(19) United States
(12) Patent Application Publication
(10) Pub. No.: US 2020/0160288 A1
(43) Pub. Date: May 21, 2020

(54) PHYSICALLY SETTLED FUTURES DELIVERY SYSTEM

(71) Applicant: Coinbase, Inc., San Francisco, CA (US)

(72) Inventors: Paul Bauerschmidt, Chicago, IL (US); Kyle D. Kavanagh, Chicago, IL (US)

(21) Appl. No.: 16/583,037

(22) Filed: Sep. 25, 2019

Related U.S. Application Data
(60) Provisional application No. 62/768,657, filed on Nov. 16, 2018.

(51) Int. Cl. G06Q 20/06; G06Q 40/04; G06Q 20/10; G06Q 20/32; H04L 29/06

(52) U.S. Cl. CPC G06Q 20/06; G06Q 40/04; H04L 63/0428; G06Q 20/32; H04L 29/06; G06Q 20/105

(57) ABSTRACT

A system and method deliver cryptocurrency on an expiring futures contract. A settlement wallet stores or manages one or more cryptographic keys that controls the transfer of cryptographic currency. The cryptographic keys are subject to a non-party's custody that guarantees fulfillment on an expiring cryptocurrency futures contract. The system and method link the settlement wallet to an exchange wallet that stores or manages one or more other cryptographic keys that controls the transfer of other cryptographic currency dynamically. The system and method physically deliver cryptocurrency to a counterparty in a futures contract.

### PRIORITY

This application claims priority to U.S. Provisional Application No. 62/768,657, filed Nov. 16, 2018, titled “Physically Settled Futures Delivery System”.

### BACKGROUND OF THE DISCLOSURE

### 1. Technical Field

This disclosure relates to distributed systems that settle digital currency futures contracts, and specifically to, systems that facilitate fulfillment of cryptocurrency futures contracts through delivery.

### 2. Related Art

Futures contracts are agreements for the future sale and purchase of items. They are generally sold on exchanges where buyers agree to receive and pay for physical items and sellers agree to deliver quantities and a grade of the items, at which time the sellers are paid. Many sellers use exchanges to protect against declining prices and many buyers use exchanges in search of profits that come with increasing prices.

Exchanges are generally not designed to serve as the principal marketplace to sell items. While a seller's delivery to a buyer can close out a futures contract, many agreements are closed out before delivery. A seller may close out a position by agreeing to purchase the same quantity and grade of items or economically related items. A buyer may close out a position by agreeing to sell the same quantity and grade of items or economically related items. The off-setting transactions need not be made between the original buyer and original seller when cleared by an intermediary. In those instances, the intermediary becomes the buyer to every seller and the seller to every buyer. Either party, the original buyer or the original seller, can therefore close out their futures positions without going into physical delivery through the intermediary netting out both of the transactions.

### BRIEF DESCRIPTION OF THE DRAWINGS

The disclosure is better understood with reference to the following drawings and description. The elements in the figures are not necessarily to scale, emphasis instead being placed upon illustrating the principles of the disclosure. Moreover, in the figures, like referenced numerals designate corresponding parts throughout the different views.

FIG. 1 shows processes that fulfill physical delivery of virtual currency transacted through futures contracts.

FIG. 2 shows a virtual exchange wallet and a virtual settlement wallet.

FIG. 3 is a process that validates and transfers ownership of virtual currency transacted through futures contracts.

FIG. 4 shows alternate processes that fulfill physical delivery of virtual currency transacted through futures contracts.

FIG. 5 is a second process that validates and transfers ownership of virtual currency transacted through futures contracts.

FIG. 6 is a third process that validates and transfers ownership of virtual currency transacted through futures contracts.

FIG. 7 shows hardware that fulfills physical delivery of virtual currency transacted through futures contracts.

FIG. 8 shows alternate hardware that fulfills physical delivery of virtual currency transacted through futures contracts.

### DETAILED DESCRIPTION

The disclosed systems and processes (referred to as the system or systems) enable physical delivery of cryptocurrency traded through futures contracts. The systems execute settlements through one or more digital ledgers. In some systems, a private or permissioned ledger is used that establishes trust without requiring a Proof-of-Work. It is fast because no Proof-of-Work is required and secure because it is a private or permissioned ledger. The private or permissioned ledger may be maintained in cold storage and may include multi signature addresses to secure ownership of digital currency. In other systems, an unlimited or nearly an unlimited number of cryptocurrency futures deliveries are made between participants or futures commissioned merchants without committing all of the transactions to a blockchain network. By adding only a limited number of transactions to the blockchain network, the system saves a significant amount of computational resources, computing power and electrical power, and delivery time by executing a limited number to the Proof-of-Work calculations through software while maintaining the validity and security of the transactions. Further, the software provides a quick and scalable way for participants to fulfill futures contracts. In other systems, transactions are pooled and submitted to the blockchain network across the network to limit latency and improve system performance. Proof-of-Work is data that requires substantial computing resources to derive. In a bitcoin context, miners work through network nodes to discover a numeric solution to a cryptographic hash function with a digest length of usually 256 bits. Nodes or full nodes are replicas of blockchain networks that track transactions that have occurred on the blockchain network. Nodes include the full blockchain transaction history for any virtual or specific cryptocurrency, or for a number of different virtual currencies.

Generally, a transaction refers to a transfer of cryptocurrency (e.g., bitcoin) from one participant to another. More precisely, a transaction may be a signed data structure expressing a transfer of value. Bitcoin transactions, for example, are transmitted over a bitcoin network, collected by and validated by miners, included in blocks, and made permanent on the blockchain network. A block is a grouping of transactions, marked with a timestamp, and a fingerprint (i.e., a distinctive and unique identifying mark or characteristic) associated only with or assigned to the previous block. The block header is hashed to produce a Proof-of-Work, thereby validating the transactions within the block. Valid blocks are added to a blockchain network by network consensus. A blockchain network is a list of validated blocks each linking to its predecessor all the way to a genesis block. A genesis block is the first block on the main-chain or secondary chain used to initialize a cryptocurrency on a blockchain network. A consensus is when several nodes, typically most of the nodes in a computing network, have all the same blocks in their locally-validated blockchain network. This should not be confused with consensus rules that are a set of validation rules that follow the full nodes to remain in consensus with other nodes. In other words, they are the set of validation rules that determine how much computation resources are required to produce a Proof-of-Work.

An exemplary peer-to-peer architecture separates the physical delivery processes from the trading processes and clearing processes that create the futures agreements and assign the obligations to fulfill the obligations called out in the futures agreements. It is fault tolerant. If one module goes down other modules or surrogate can come on-line automatically to complete a particular task or implement a specific function by providing the replacement module with a copy of only a portion of the data that the peer-to-peer architecture processes. The processing may be distributed at power-up or during operation through token delegations that grant processing privileges and/or access rights to modules. By distributing processing privileges and/or access rights during operation, the number of modules processing settlement and delivery can also change to meet demand. For example, during a Black Friday Market Crash, additional modules can be brought on-line and spread across the network to limit latency. So, when a dramatic shift in financial markets occur, more modules may be brought on-line and/or certain functions may be assigned automatically from one module to the next. For example, the provisioning and delivery of invoices normally executed by a central counterparty module (CCP module) may be automatically reassigned to a custodian module through a token delegation. A delegation may occur when a bottleneck in the invoicing process is detected or predicted. An independent manager module, or a manager module integrated with the central counterparty module, custodian module, etc., or distributed there between, may monitor system operations and make delegations through downloadable processing profiles. In some systems, the processing privileges and/or access rights delegations may be based on delivery policies, cryptocurrency volatility, settlement and/or trading volumes, server/processor loads, memory use/consumption, etc. Some delivery modules make module delegations based on comparisons to benchmarks that are part of the downloadable processing profiles stored in memory and thus make delegations based on detected conditions or behavior that generally precede and/or may occur during a Black Friday Market Crash like event. By modifying system configurations prior to an event, the processing profiles may protect against system failures that would otherwise occur during an unknown or an unanticipated event. The downloadable processing profiles are referred to as downloadable because they are generated separately and apart from the systems. The downloadable processing profile contain rules and/or data that establish enterprise configurations and ensure optimal operating conditions. Exchanges, clearing agencies, and/or asset custodians can also easily tailor or customize one or more downloadable processing profiles to their own operating policies, types of financial currency in delivery, and/or their own operating rules or rules of the market. As a result, an enterprise may ensure it is compliant with the most current rules and regulations of the market and the system requires fewer modifications to service different exchanges and digital currency types. These improvements enhance computer efficiency reduce electrical power consumption, and improve user experiences.

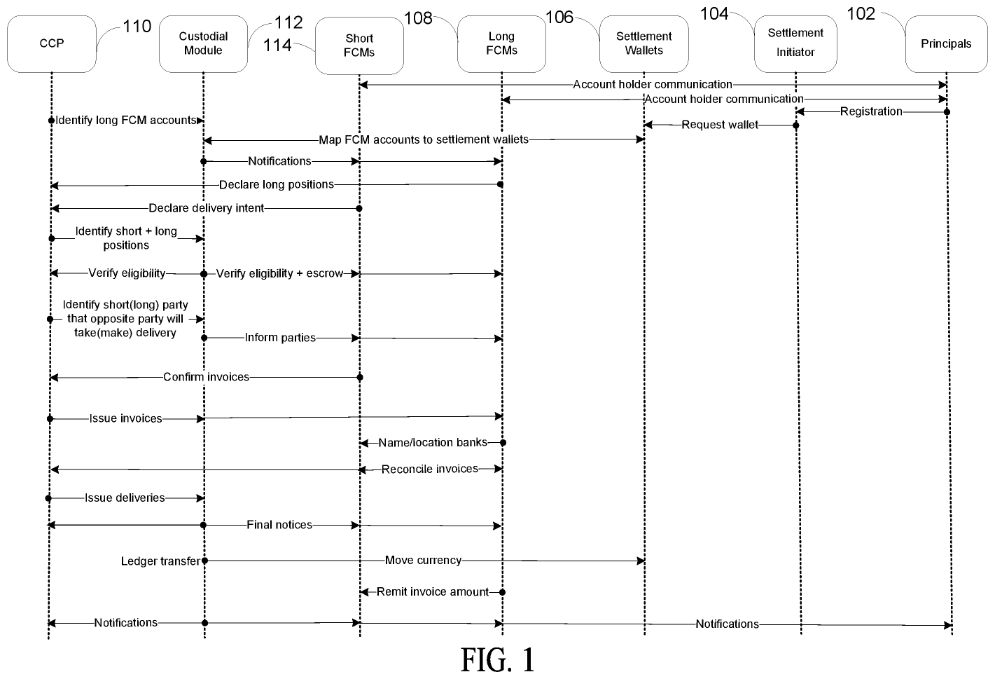

In FIG. 1 a delivery session may be preceded by or accompanied by communications between a Future Commissioned Merchant (referred to as an FCM or a clearing firm) modules 108 and 114 and trading entity modules (referred to as a Principals module 102) through Application Programming Interfaces (APIs). An FCM may manage contact with end-users and manages some of the data processed by the central counterparty module (CCP module) 110. The trading entities may include individual retail customers, proprietary trading firms, Commodity Trading Advisors (CTAs), hedge fund managers, asset managers, bank proprietary account advisors, etc. Generally, end users maintain accounts accessible and/or serviced by FCM modules 108 and 114 that enable access to exchanges.

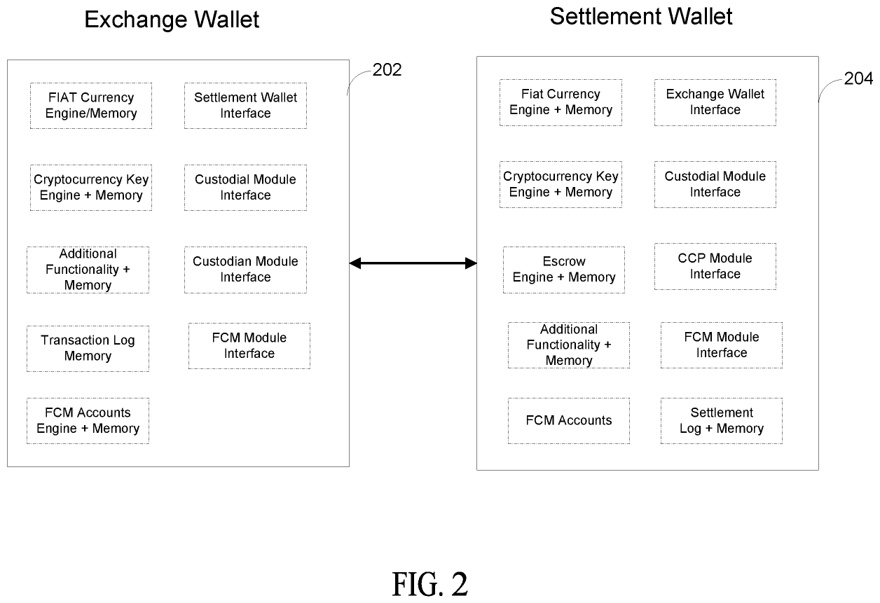

Before delivery begins, principals may initiate a registration through a settlement initiator 104. Besides initiating sessions, a settlement initiator 104 may terminate a session and maintain sessions in response to a registration request from the principals module 102. The registration request triggers the creation of a new settlement wallet 204 (via the settlement wallets module 106) that sits beside a user's exchange wallet 202, meaning it is associated with or dynamically linked to the user's exchange wallet 202 as shown in FIG. 2. Generally, the term dynamically refers to a link that is automatically created in response to a preceding event such as a registration, for example.

An exchange wallet 202 is an application that serves as a user's primary API. The exchange wallet 202 controls access to the user's money, manages and stores the user's digital currency addresses and private keys (e.g., secret keys), tracks and logs balances and transactions, and is used to create and sign transactions. From a computer programmer's perspective, an exchange wallet 202 may refer to the data structure itself used to store and manage a user's private keys and transactions. Generally, there are two types of exchange wallets 202: one in which keys are independently generated (meaning they are not related) from a random number and the second where all keys are generated from a single master key. Generally, exchange wallets 202 are used to send, receive, and store digital currency. The exchange wallet may be used to buy or sell futures contracts

End-users and the custodial module 112 may move funds (e.g., fiat currency, digital currency via key transfers, etc.) to and/or from settlement wallet currency accounts automatically or using transfer interfaces and accounts functions that dynamically link the exchange wallet 202 to the settlement wallet 204. The custodial module 112 and exchange wallet module 106 also map and link FCM accounts to the exchange wallet 202 and/or the settlement wallet 204 in response to the CCP modules 110 identification of the FCM accounts to the custodial module 112. Generally, mapping creates an association between the FCM accounts and the end-user behind the settlement wallet 204. The mapping and dynamic linking occurs when the exchange wallet 202 and settlement wallet 204 are created and serve through many delivery cycles until terminated or modified by an operational flow.

Before the delivery process begins, the custodial module 112 generates and transmits notification messages to the short and long FCM modules 114 and 108 as shown in FIG. 1. Generally, the term “long” refers to buyers in futures contracts and the term “short” refers to the “sellers” in futures contracts. The notification message may be sent out multiple times a day and may include fields that identify the long and/or short positions in expiring futures contracts held in an FCM's account, a statement of balance, and the minimum amount of funds that are required in the end-user's settlement account to maintain their long and short positions. In some systems, the CCP module 110 sets the minimum levels of funds per end-user. If the minimum levels are not attained or maintained just prior to or during delivery month (e.g., one or more days before the expiring contracts delivery month) before the futures contract is settled, the custodial module 112 may automatically initiate a transfer between an end-user's exchange wallet 202 and settlement wallet 204 on behalf of the end-user, or trigger the CCP module 110 to close out the end-user's open futures positions.

The delivery process begins with each long FCM module 108 notifying the CCP module 110 of the long positions in expiring contracts it holds on account. The payload of the message may include the date at which each long position was initially made, a corresponding unique end-user (or customer) identifier, the total number of contracts held in each end-user (or customer) account, and the total number of contracts held in the FCM's proprietary trading accounts referred to as its house accounts. Thereafter, the short FCM modules 114 notifies the CCP module 110 of its short position holder's intention to make delivery. The payload of the notification message may include the date at which each short position was initially made, the corresponding unique end-user (or customer) identifier, the total number of contracts held in each end-user (or customer) account, and the total number of contracts held in the FCM's house accounts.

In response to the notifications, the custodial module 112 verifies eligibility of delivery to the CCP module 110 for each end-user and their specific position levels, and thereafter limits withdrawal rights to the funds held in the end-user exchange wallet 202 that are needed to satisfy the expiring contracts by designating them to an escrow account. The CCP module 110 then matches long positions declared by the long FCM modules 108 to short positions declared by the short FCM modules 114. The CCP module 110 views the short positions and long positions according to each FCM firm. A FCM's short position is the sum of its short positions held in its end-user accounts and its house accounts that have been declared for delivery by the short FCM module 114. A FCM's long position is the sum of its long positions held in its end-user accounts and its house accounts in the expiring contract.

While order matching varies with alternate CCP modules, order matching may occur in the order in which a position was established. Matching may begin with the oldest long position followed by other long positions having the next oldest date in sequence, etc. Long FCMs (the communicate via Long FCM modules 108) may be matched to short FCMs (that communicate via Short FCM modules 114) directly based on the total number of short contracts declared for delivery that equals the total number of long contracts declared for delivery. Any remaining unmatched short positions are then assigned to open long positions by random selection and prorated when the eligible pieces (e.g., the object of the contracts) are not equal. Once the long pool has been drawn in satisfaction of the short pool, the unmatched long positions are relisted by the date in which they were established and pushed to the next delivery cycle if no net changes are made in their contract holdings. Long positions may be reduced by an offsetting sale or an exchange for economically related items prior to the next delivery cycle.

Once matched, the CCP module 110 notifies the custodial module 112, which then informs both the short FCM modules 114 and the long FCM modules 108 via electronic assignment notices informing the parties to whom they have been matched. The short FCM modules 114 prepare and transmit invoices for the long FCM modules 108 to whom they have been matched based on the basis of the appropriate contract price that are electronically confirmed to the CCP module 110. The CCP module 110 then issues the invoices to the custodial module 112, which informs the long FCM modules 108, which provides the name and location of its banks to the short FCM modules 114 making deliveries. The short FCM modules 114 and long FCM modules 108 then reconcile invoice differences after which the short FCM's modules 114 notifies the CCP modules 110 of the final invoice notices. The CCP module 112 issues the final delivery reports to the custodial module 112, which transmits the final invoice notices to the CCP module 110, the short FCM module 114, and long FCM module 108.

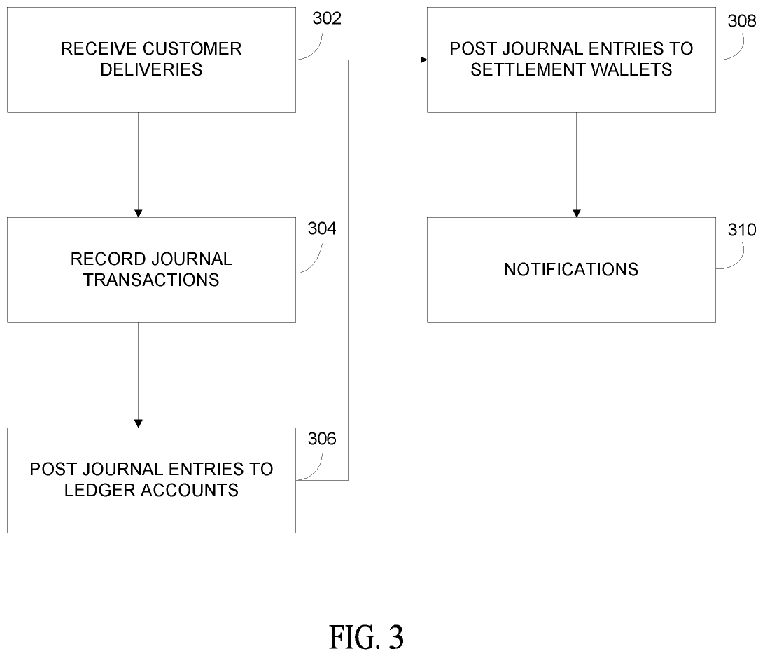

In FIG. 1 the custodial modules 112 make the physical deliveries that result in the settlement of the futures contracts. Unlike conventional exchanges, in which the short FCMs deposit the eligible physical pieces of the futures contract into a warehouse (e.g., for commodities) or a self-controlled bank (e.g., treasury securities), in FIG. 1, the custodial module 112 moves the cryptocurrency from one FCM account to another FCM account through a private or permissioned journal. As shown in FIG. 3 upon receipt of the notification from the CCP module 110 of the contract deliveries at 302, the custodial module 112 records the change in ownership of the secret keys (a.k.a. the private key) that unlocks the cryptocurrency that is generally held in a depository at 304. Generally, a depository refers to an entity that holds cryptocurrency in bulk form for their participants and maintain ownership records of the cryptocurrency on their private (virtual) books. The journal entries may include the dates, descriptions, and the amount of cryptocurrency sold. In some systems, a double-entry system is used that includes a debit and credit that are equal and opposite entries. The entries may include the date at which each short (long) positions were settled, the corresponding unique end-user (or customer) and FCM identifiers, and the total amount of cryptocurrency pieces that was made (taken) for delivery. After recording the transactions into the journals of the individual account holders, the journal entries are moved to the FCMs general ledger and the balances on each account are rendered. In FIG. 1, only the depository and/or custodial module 112 has the authority to commit transactions to the journals and general ledger. By retaining central authority of the cryptocurrency and/or designation of ownership of cryptocurrency, the system provides improved record keeping, reduced reconciliations, more timely transactions, better quality data, and an established trust without requiring a Proof-of-Work.

As shown in FIG. 3, once the transactions are posted to the journals and general ledgers, the custodial module 112 post the transactions and withdrawals the escrow requirements on the settlement wallet 204 at 308 while the long FCM modules 108 remits the invoice amounts to the short FCM modules 114 upon the posting to the general ledgers. Thereafter, the CCP module 110, short FCM modules 114, long FCM modules 108 and principal modules 102 that are parties to the automated settlement are notified of the deliveries at 310.

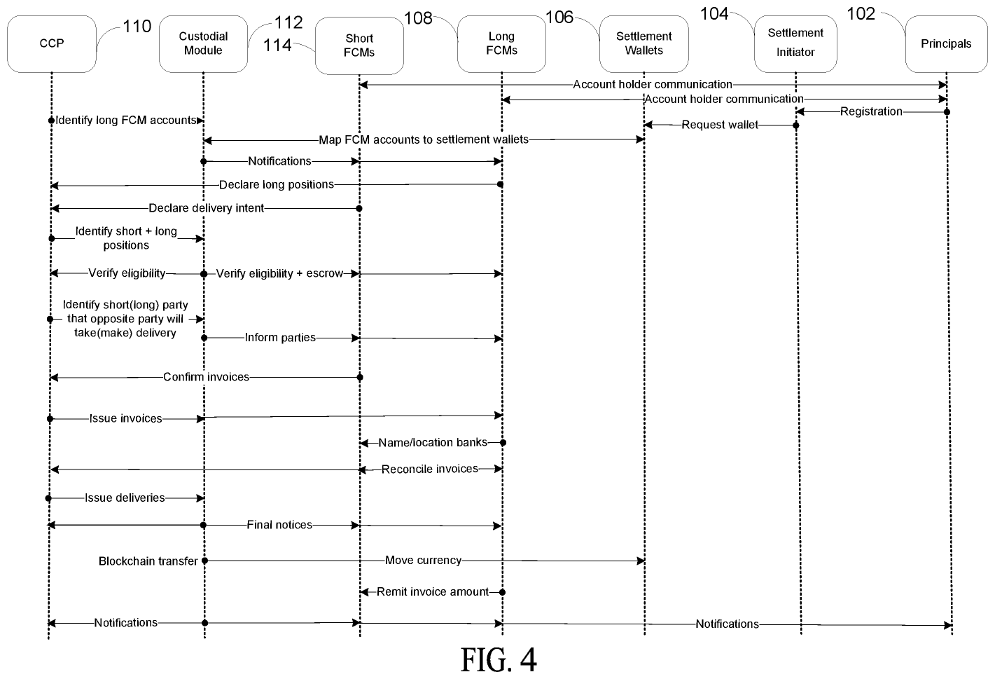

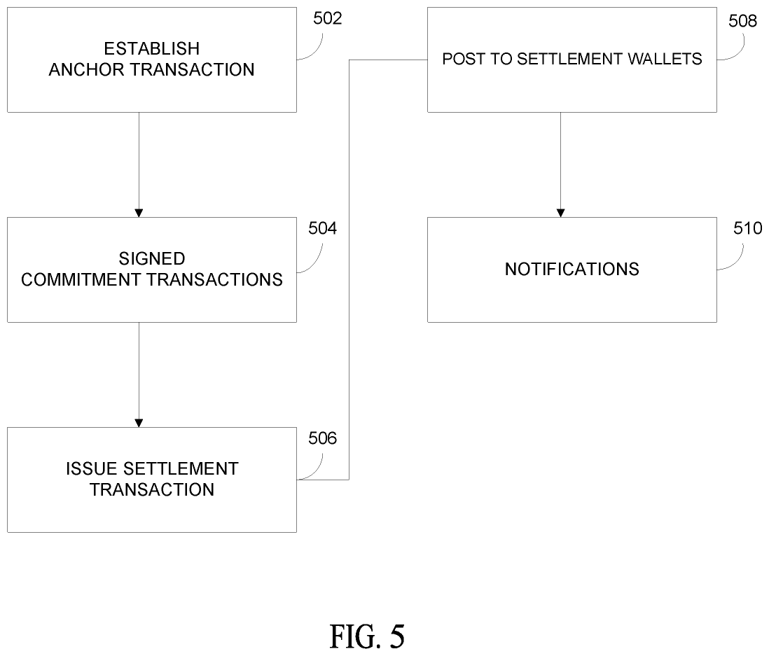

In FIG. 4, the alternate system may execute the process flow described above except the ledger ownership transfer occurs via a trusted mechanism and a blockchain network as shown by the process flow in FIG. 5. Transactions, which would be validated if settled on the cryptocurrency blockchain network, are held off-chain (e.g., off of the blockchain network) via the private or permissioned ledger for eventual batch settlement in this alternate system. In this system, a state channel is created before a delivery occurs between the custodial module 112 and short FCM modules 114 and between the custodial module 114 and the long FCM modules 108. Generally, the term state channel refers to a virtual construct that represents a change of state effected between the custodial module 112 and the FCM modules 108 and 114.

In FIG. 5, a funding transaction may create a state channel to lock a shared state on the blockchain network at 502. A funding transaction may have one or more inputs from the custodial module 112 and each of the short/long FCM modules 114 and 108 that exceed the channel capacity to cover the blockchain network transaction fee. With the state channel setup, the two modules (e.g., the custodial module 112 and the short FMC module 114 or the custodial module 112 and the long FCM module 108) may execute one or more signed transactions that transfer ownership of cryptocurrency that could be validated by the blockchain network, but are held off-chain by each module pending the termination of the channel at 504. Later signed ownership-transactions invalidate prior ownership transaction, so only the most current ownership-transaction is valid. Further, all of the intervening ownership transactions need not be seen or shared with the other modules, the public or entities not a party to the transaction. Generally, the off-chain transactions may also be viewed as a virtual construct that represents the chain of title of the cryptocurrency, where the number of transactions exchanged represent or add to the quantity of eligible pieces under contract. In this process, ownership transfer occurs as quickly as a module drafts, digitally signs, and transmits the ownership-transfer to the other module, allowing the custodial and FCM modules 112, 108, and 114 to exchange hundreds of transactions per second. The channel may be closed through a cooperative or unilateral ownership transaction by the custodial module 112 submitting a final commitment transaction to the blockchain network at 506. At 508, the custodial module 112 updates settlement wallet 204 at 508 post-settlement. The final commitment transaction represents the final ownership state of the cryptocurrency and is settled on the blockchain network. Thereafter, the CCP module 110, short FCM modules 114, long FCM modules 108, and principal modules 102 that are parties to the automated settlement are notified of the deliveries that were made and taken at 510.

In FIG. 5 the off-chain transactions are implemented with many digital signature algorithms. One exemplary method may have the FCM produce a one-way hash of the transaction document. It may then encrypt the hash with its private key, thereby signing the document. The signature and the date and time of the signature are then attached to the transaction document. The FCM then sends the transaction document and the signed hash to the CCP module 110. The CCP module 10 produces a one-way hash of the signed document. It then decrypts the signed hash with the FCM's public key. If the signed hashes match, the signature is valid. The CCP module 110 stores the timestamp in a database. If the message is received a second time, the CCP module 110 can check the timestamp against its database. If there is a match the later transactions are ignored.

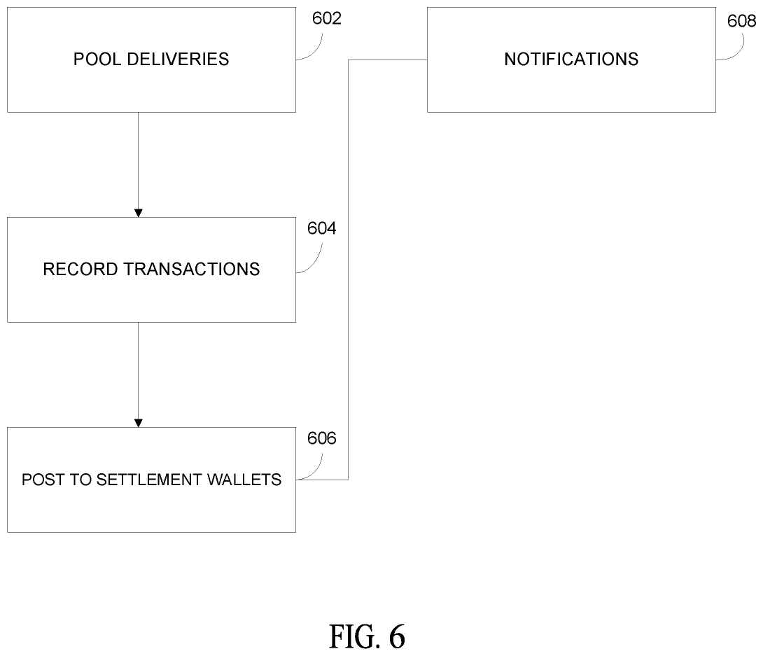

An alternate ownership transfer may also be executed in FIGS. 1 and 4 by pooling the cryptocurrency deliveries that result from the settlement of the expiring futures contract as shown in FIG. 6. The ownership-transfer occurs by first grouping together the cryptocurrencies by FMC and/or end-user at 602. Changes in ownership are recorded by the custodial module 112 committing all of the deliveries made and taken to the blockchain network at 604. The transactions may be recorded as a transaction between the custodial module 112 and the end-user and/or the custodial module 112 and/or long FCM modules 114 and 108. At 606, the custodial module 112 updates settlement wallet 204 at 508. Thereafter, the CCP module 110, short FCM modules 114, long FCM modules 108 and principal modules 102 that are parties to the automated settlement are notified of the deliveries that were made and taken at 608. There are many benefits to this process. For example, the custodial module 122 need not retain centralized authority and control over the end-user's funds, because the private keys are retained by the FCM modules and/or end users not the custodial module 112.

Each ownership-transfer process described provides one or more specific advantage or serves a particular purpose to solve a problem rather than serving as a design choice. Among the advantages and particular purposes served include auditability, improved record keeping, reduced reconciliations, more timely transactions, better quality data, and an established trust without requiring a Proof-of-Work when ownership transfers occur through a private or permissioned journal and ledger. Among the advantages and particular purposes served includes high transaction throughput, low latency, strong consistency and integrity (each transaction is signed), very fine granularity, and immutability (when submitted to the blockchain network) when a state channel is used to transfer ownership. Immutability, transaction atomicity, replication, forgery protection, and predictable issuance are some of the many advantages and particular purposes served when pooling is used. In some systems, combination of private or permissioned journal and ledger transfers, state channel transfers, and blockchain network transfers provide the benefits and advantages described above any overcome the deficiencies described.

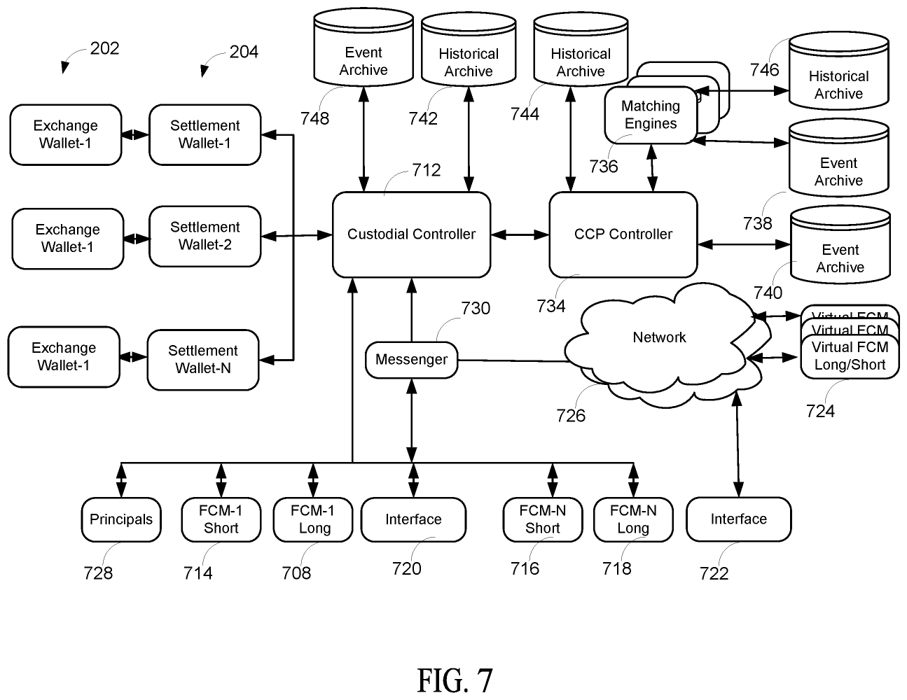

FIG. 7 shows the hardware that fulfills the delivery of cryptocurrency transacted through futures contracts. The hardware executes the process flows described above and those shown in FIGS. 1-6 automatically. In FIG. 7, the custodial controller 712 interfaces the CCP controller 734 and the FCM engines 708 and 714-718. An engine is a processor, a device, or a program that manages and manipulates data. For example, a short FCM engine contains the tools for executing short FCM functions, such as making deliveries of cryptocurrency. A long FCM engine contains the tools for executing long FCM functions, such as taking deliveries of cryptocurrency. The term module refers to an assembly (e.g., a distinct hardware unit) for providing a computing function within a computer system to execute one or more functions that are recited in the particular context that the term is used. The custodial controller 712 also connects to external hardware, principal input/outputs 728 and virtual long/short FCM engines 724 through interfaces 720 and 722 directly and/or via a cloud-based networks 726. Interfaces 720 and 722 may also serve as a point of interaction or a communication between the modules and any other entities, such as other computers. An interface, for example, may also comprise a human machine interface where interactions between the modules and a position holder occurs.

In FIG. 7, messenger 730 connects to the custodial controller 712, cloud-based networks 726, interfaces 720 and 722, and FCM engines 708, 714-718, and 724 directly and couples the CCP controller 734 indirectly. Messenger 730 sends messages, notifications and enables the exchange of notifications as well as reacts to other module messages and interact with bots. In FIG. 7, the CCP controller 734 coordinates the cryptocurrency contract deliveries. CCP controller 734 interfaces a matching engine 736 that matches long positions to short positions. An exemplary sequence of computerized directions/rules are described above. A delivery action or event processed by the custodial controller 712, CCP controller 734, or matching engines 736 of a contract delivery month are stored in event archives 738, 740, and 748 previous actions or events are stored in the historical archives 742-746. The exchange and settlement wallets 202 and 204 serve as the primary end-user interface for the delivery of a futures contracts. The wallets 202 and 204 control access to the end-user's money, managing keys and addresses, tracking balances, creating and signing transactions, etc.

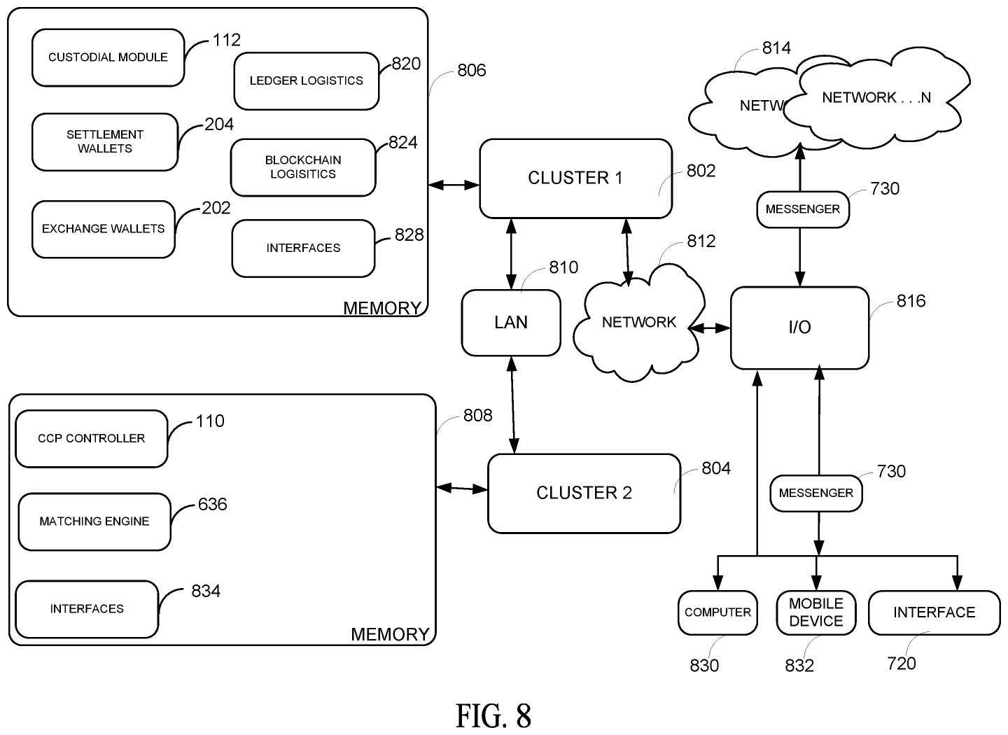

FIG. 8 is a block diagram of an alternative system that may execute the process flows described above and those shown in FIGS. 1-6 automatically. The system comprises servers or clusters 802 and 804 (referred to as clusters), non-transitory media such as a memory 806 and 808 (the contents of which are accessible to clusters 802 and 804), private 810 and public networks 812 and 814, and an I/O interface 816. The I/O interface 816 or LAN 810 connects devices and local and/or remote applications such as, for example, messengers 730, other computers 830, mobile devices 832, interfaces 720, long and short FCM modules (not shown), a session initiator (not shown), principal modules (not shown). The memories 806 and 808 stores instructions which when executed by the clusters 802 and 804 causes the system to render some or all of the functionality associated with facilitating delivery and subsequent fulfillment of a futures contract. Memory 806 stores instructions, which when executed by cluster 802, causes the system to render the functionality associated with the custodial module 112, settlement wallets 204, exchange wallets 202, ledger logic 820, blockchain network logic 824, and input/output functions 828. Memory 804 stores instructions, which when executed by cluster 804, causes the system to render the functionality associated with the CCP controller 110, matching engine 636, and input/output functions 834.

The memories 806 and 808 and/or other storage disclosed herein may retain an ordered listing of executable instructions for implementing the functions described above in a non-transitory computer code. The machine-readable medium may selectively be, but not limited to, an electronic, a magnetic, an optical, an electromagnetic, an infrared, or a semiconductor medium. A non-exhaustive list of examples of a machine-readable medium includes: a portable magnetic or optical disk, a volatile memory, such as a Random-Access Memory (RAM), a Read-Only Memory (ROM), an Erasable Programmable Read-Only Memory (EPROM or Flash memory), or a database management system. The memories 806 and 808 may comprise a single device or multiple devices that may be disposed on one or more dedicated memory devices or disposed on a processor or other similar device. The engines may comprise a processor or a portion of a program that executes or supports recognition system or processes. When functions, steps, etc. are said to be “responsive to” or occur “in response to” another function or step, etc., the functions or steps necessarily occur as a result of another function or step, etc. It is not sufficient that a function or act merely follow or occur subsequent to another. Computer-mediated technology enables human communication that occurs through two or more electronic devices. The devices may provide input from various sources including, but not limited to, audio, text, images, video, etc. In the context of futures contracts, financial products that are physically delivered require the counterparties to either physically tender the financial products or take physical delivery of the financial products through an Exchange.

While each of the systems and methods shown and described herein operate automatically and operate independently, they also may be encompassed within other systems and methods including any number (N) of iterations of some or all of the process used to recognize input, render recognized results, and/or render an output. Alternate delivery and fulfillment systems may include any combinations of structure and functions described or shown in one or more of the FIGS. These delivery and fulfillment systems are formed from any combination of structures and functions described. Some with all of the structures and functions some with less. Any subset of structures and functions may be claimed. Further, the structures and functions may process additional or different input.

The functions, acts or tasks illustrated in the FIGS. or described may be executed in response to one or more sets of logic or instructions stored in or on non-transitory computer readable media as well. The functions, acts or tasks are independent of the particular type of instructions set, storage media, processor or processing strategy and may be performed by software, hardware, integrated circuits, firmware, micro code and the like, operating alone or in combination.

The disclosed systems enable physical delivery of cryptocurrency traded through futures contracts. The systems execute settlements through one or more digital ledgers. In some systems, a private or permissioned ledger is used that establishes trust without requiring a Proof-of-Work. It is fast because no Proof-of-Work is required and secure because it a private or permissioned ledger. The private or permissioned ledger may be maintained in cold storage and may include multisignature addresses to secure ownership of cryptocurrency. In other systems, an unlimited or nearly an unlimited number of cryptocurrency futures deliveries and fulfillments are made between participants or futures commissioned merchants without committing all of the transactions to a blockchain network. The grouping of transactions marked with a timestamp and a fingerprint of the previous block and hashed to validate the transactions may be linked to its predecessor bocks all the way back to the first block in the blockchain network. By adding only, a limited number of transactions to the blockchain network, the system saves a significant amount of computational resources, computing power, and delivery time by executing a limited number of the Proof-of-Work calculations while maintaining the validity and security of the transactions. Further, the protocol provides a quick and scalable way for participants to fulfill futures contracts. In other systems, transactions are pooled and submitted across the network through a blockchain network to limit latency and improve system performance.

The subject-matter of the disclosure may also relate, among others, to the following aspects (referenced by numbers):

1. A non-transitory machine-readable medium encoded with machine-executable instructions, where execution of the machine-executable instructions is for:

generating a settlement wallet that stores or manages one or more cryptographic keys that controls a transfer of a cryptographic currency, where the one or more cryptographic keys are subject to a non-party's custody that guarantees a fulfillment on an expiring cryptocurrency futures contract, where the non-party is not an original party to the expiring cryptocurrency futures contract.

linking the settlement wallet to an exchange wallet that stores or manages the one or more other cryptographic keys that controls the transfer of other cryptographic currency dynamically, where the one or more other cryptographic keys are used to buy or sell a cryptocurrency futures contract; and

executing a physical delivery on the expiring cryptocurrency futures contract by generating a state channel through a transaction that locks a shared state on a blockchain network;

where the physical delivery occurs through one or more digitally signed transactions that transfer ownership of the cryptographic currency that would be validated by the blockchain network but are not submitted to blockchain network.

2. The non-transitory machine-readable medium of any aspect 1 further comprising receiving a financial security in exchange for the cryptographic currency.
3. The non-transitory machine-readable medium of any aspects 1 to 2 where the one or more cryptographic keys are held in a depository that holds the cryptographic keys in bulk.
4. The non-transitory machine-readable medium of any aspects 1 to 3 further comprising mapping an FCM account to the settlement wallet.
5. The non-transitory machine-readable medium of any aspects 1 to 4 further comprising closing the state channel by submitting a commitment transaction to the blockchain network.
6. The non-transitory machine-readable medium of any aspect 5 where the commitment transaction transfers the ownership of the cryptographic currency.
7. The non-transitory machine-readable medium of any aspects 1 to 6 further comprising updating the settlement wallet by removing from or adding to the cryptocurrency that is stored in or managed by the settlement wallet.
8. The non-transitory machine-readable medium of any aspects 1 to 7 where the one or more signed transactions that transfer ownership of the cryptographic currency sum to a quantity of the cryptographic currency exchanged.
9. A non-transitory machine-readable medium encoded with machine-executable instructions, where execution of the machine-executable instructions is for:

generating a settlement wallet that stores or manages one or more cryptographic keys that controls a transfer of a cryptographic currency, where the one or more cryptographic keys are subject to a non-party's custody that guarantees a fulfillment on an expiring cryptocurrency futures contract, where the non-party is not an original party to the expiring cryptocurrency futures contract;

linking the settlement wallet to an exchange wallet that stores or manages one or more other cryptographic keys that controls the transfer of other cryptographic currency dynamically, where one or more other cryptographic keys are used to buy or sell a cryptocurrency futures contract; and

executing a physical delivery on the expiring cryptocurrency futures contract by recording one or more signed transactions in a distributed ledger that records the transfer of ownership of the cryptographic currency.

10. The non-transitory machine-readable medium of any aspect 9 further comprising receiving a financial security in exchange for the cryptographic currency.
11. The non-transitory machine-readable medium of any aspects 9 to 10 where the one or more cryptographic keys are held in a depository that holds the cryptographic keys in bulk.
12. The non-transitory machine-readable medium of any aspects 9 to 11 further comprising mapping an FCM account to the settlement wallet.
13. A computer implemented method comprising:

generating a settlement wallet that stores or manages one or more cryptographic keys that controls a transfer of a cryptographic currency, where the one or more cryptographic keys are subject to a non-party's custody that guarantees fulfillment on an expiring cryptocurrency futures contract;

linking the settlement wallet to an exchange wallet that stores or manages one or more other cryptographic keys that controls the transfer of other cryptographic currency dynamically, where the one or more other cryptographic keys are used to buy or sell a cryptocurrency futures contract; and

executing a physical delivery on the expiring cryptocurrency futures contract by submitting signed transactions to a blockchain network.

14. The computer implemented method of any aspects 13 further comprising receiving a financial security in exchange for the cryptographic currency.
15. The computer implemented method of any aspects 13 to 14 where the one or more cryptographic keys are held in a depository that holds the cryptographic keys in bulk.
16. The computer implemented method of any aspects 13 to 15 further comprising mapping an FCM account to the settlement wallet.
17. The computer implemented method of any aspects 13 to 16 further comprising closing a state channel by submitting a commitment transaction to the blockchain network.
18. The computer implemented method of any aspects 17 where the commitment transaction transfers the ownership of the cryptographic currency.
19. The computer implemented method of any aspects 13 to 18 further comprising updating the settlement wallet by removing or adding to the cryptocurrency that is stored or managed in the settlement wallet.
20. The computer implemented method of any aspects 13 to 19 where one or more signed transactions that transfer ownership of the cryptographic currency sum to a quantity of the cryptographic currency exchanged.

Other systems, methods, features and advantages will be, or will become, apparent to one with skill in the art upon examination of the figures and detailed description. It is intended that all such additional systems, methods, features and advantages be included within this description, be within the scope of the disclosure, and be protected by the following claims.

What is claimed is:

1. A non-transitory machine-readable medium encoded with machine-executable instructions, where execution of the machine-executable instructions is for:
generating a settlement wallet that stores or manages one or more cryptographic keys that controls a transfer of a cryptographic currency, where the one or more cryptographic keys are subject to a non-party's custody that guarantees a fulfillment on an expiring cryptocurrency futures contract, where the non-party is not an original party to the expiring cryptocurrency futures contract.
linking the settlement wallet to an exchange wallet that stores or manages the one or more other cryptographic keys that controls the transfer of other cryptographic currency dynamically, where the one or more other cryptographic keys are used to buy or sell a cryptocurrency futures contract; and
executing a physical delivery on the expiring cryptocurrency futures contract by generating a state channel through a transaction that locks a shared state on a blockchain network,
where a physical delivery occurs through one or more digitally signed transactions that transfer ownership of the cryptographic currency that would be validated by the blockchain network but are not submitted to blockchain network.

2. The non-transitory machine-readable medium of claim 1 further comprising receiving a financial security in exchange for the cryptographic currency.

3. The non-transitory machine-readable medium of claim 1 where the one or more cryptographic keys are held in a depository that holds the cryptographic keys in bulk.

4. The non-transitory machine-readable medium of claim 1 further comprising mapping an FCM account to the settlement wallet.

5. The non-transitory machine-readable medium of claim 1 further comprising closing the state channel by submitting a commitment transaction to the blockchain network.

6. The non-transitory machine-readable medium of claim 5 where the commitment transaction transfers the ownership of the cryptographic currency.

7. The non-transitory machine-readable medium of claim 1 further comprising updating the settlement wallet by removing from or adding to the cryptocurrency that is stored in or managed by the settlement wallet.

8. The non-transitory machine-readable medium of claim 1 where the one or more signed transactions that transfer ownership of the cryptographic currency sum to a quantity of the cryptographic currency exchanged.

9. A non-transitory machine-readable medium encoded with machine-executable instructions, where execution of the machine-executable instructions is for:
generating a settlement wallet that stores or manages one or more cryptographic keys that controls a transfer of a cryptographic currency, where the one or more cryptographic keys are subject to a non-party's custody that guarantees a fulfillment on an expiring cryptocurrency futures contract, where the non-party is not an original party to the expiring cryptocurrency futures contract;
linking the settlement wallet to an exchange wallet that stores or manages one or more other cryptographic keys that controls the transfer of other cryptographic currency dynamically, where one or more other cryptographic keys are used to buy or sell a cryptocurrency futures contract; and
executing a physical delivery on the expiring cryptocurrency futures contract by recording one or more signed transactions in a distributed ledger that records the transfer of ownership of the cryptographic currency.

10. The non-transitory machine-readable medium of claim 9 further comprising receiving a financial security in exchange for the cryptographic currency.

11. The non-transitory machine-readable medium of claim 9 where the one or more cryptographic keys are held in a depository that holds the cryptographic keys in bulk.

12. The non-transitory machine-readable medium of claim 9 further comprising mapping an FCM account to the settlement wallet.

13. A computer implemented method comprising:
generating a settlement wallet that stores or manages one or more cryptographic keys that controls a transfer of a cryptographic currency, where the one or more cryptographic keys are subject to a non-party's custody that guarantees fulfillment on an expiring cryptocurrency futures contract;
linking the settlement wallet to an exchange wallet that stores or manages one or more other cryptographic keys that controls the transfer of other cryptographic currency dynamically, where the one or more other cryptographic keys are used to buy or sell a cryptocurrency futures contract; and
executing a physical delivery on the expiring cryptocurrency futures contract by submitting signed transactions to a blockchain network.

14. The computer implemented method of claim 13 further comprising receiving a financial security in exchange for the cryptographic currency.

15. The computer implemented method of claim 13 where the one or more cryptographic keys are held in a depository that holds the cryptographic keys in bulk.

16. The computer implemented method of claim 13 further comprising mapping an FCM account to the settlement wallet.

17. The computer implemented method of claim 13 further comprising closing a state channel by submitting a commitment transaction to the blockchain network.

18. The computer implemented method of claim 17 where the commitment transaction transfers the ownership of the cryptographic currency.

19. The computer implemented method of claim 13 further comprising updating the settlement wallet by removing or adding to the cryptocurrency that is stored or managed in the settlement wallet.

20. The computer implemented method of claim 13 where one or more signed transactions that transfer ownership of the cryptographic currency sum to a quantity of the cryptographic currency exchanged.
